(19) United States
(12) Patent Application Publication
(10) Pub. No.: US 2017/0260949 A1
(43) Pub. Date: Sep. 14, 2017

(54) NOZZLE NEEDLE FOR A FUEL INJECTION DEVICE, AND FUEL INJECTION DEVICE

(71) Applicant: Robert Bosch GmbH, Stuttgart (DE)

(72) Inventors: Wilhelm Christ, Ludwigsburg (DE); Lars Ulrich, Leonberg (DE); Maike Hekel, Steinheim (DE)

(21) Appl. No.: 15/509,256

(22) PCT Filed: Jul. 30, 2015
(86) PCT No.: PCT/EP2015/067483

§ 371 Date: Mar. 7, 2017

(30) Foreign Application Priority Data
Sep. 8, 2014 (DE) 10 2014 217 935.1

(51) Int. Cl. F02M 61/10

(52) U.S. Cl. CPC F02M 61/10

(57) ABSTRACT

The invention relates to a nozzle needle (10) for a fuel injection device (100), in particular a fuel injector, comprising a nozzle needle tip (12) which is connected to a nozzle needle shaft (11). The nozzle needle tip (12) and the nozzle needle shaft (11) consist of different materials. According to the invention, the nozzle needle shaft (11) has a receiving area (20) formed by a blind bore (21) for the nozzle needle tip (12). The base (22) of the receiving area (20) forms an axial stop for the nozzle needle tip (12), and the nozzle needle tip (12) has an at least approximately constant diameter (d) within the receiving area (20), said diameter simultaneously forming the largest diameter of the nozzle needle tip (12).

### BACKGROUND OF THE INVENTION

The invention relates to a nozzle needle for a fuel injection device. The invention also relates to a fuel injection device using a nozzle needle.

A generic nozzle needle is known from the applicant's DE 10 2004 028 617 A1. The known nozzle needle has a sleeve-shaped nozzle needle shank which, on the side facing toward the injection openings, is connected to a nozzle needle tip. In particular, it is provided that the nozzle needle tip is composed of sintered metal, while the nozzle needle shank is composed for example of tool steel. Furthermore, in the case of the known nozzle needle, it is provided that the nozzle needle shank is connected, on the side situated opposite the nozzle needle tip, to a sleeve-shaped guide section which is formed as a separate component and which is likewise composed of sintered metal. The nozzle needle tip, which is of mushroom-shaped form, has a substantially conical form in the region projecting out of the nozzle needle shank. Within the nozzle needle shank, the nozzle needle tip has a fastening region of cylindrical form, wherein a force-fitting connection is realized, by way of a shrink-fit or press-fit connection, between the fastening region of the nozzle needle tip and the inner wall of the nozzle needle shank.

A disadvantage of the nozzle needle known from the cited document is that, through the selection of different materials for the nozzle needle shank and the nozzle needle tip, although the respective function can be optimized, the formation of a shrink-fit or press-fit connection between the nozzle needle shank and the nozzle needle tip is however relatively cumbersome owing to the relatively small diameter of the components and the manufacturing tolerances, or high-quality and exact manufacturing of the components is necessary. Furthermore, the production of a nozzle needle tip which has different shapes and/or diameters is duly possible relatively easily if it is composed of sintered metal, but the formation of a nozzle needle tip from another material and/or by means of a different manufacturing technique, in which a blank must be correspondingly shaped or subjected to cutting machining, is relatively cumbersome.

Furthermore, EP 1 059 437 B1 has disclosed a nozzle needle in which the nozzle needle tip is received in a receptacle in the form of a blind bore in a nozzle needle shank. Furthermore, the nozzle needle tip is arranged such that it can perform stroke movements in an axial direction of the nozzle needle shank, wherein a sleeve which is likewise arranged in the nozzle needle shank in the region of the recess limits the stroke of the nozzle needle tip in the direction of the inlet openings of the fuel injector. The nozzle needle known from the cited document makes it possible, through pressurization with the fuel pressure in the recess on the rear side of the nozzle needle tip, for the nozzle needle tip to be moved with a time delay with respect to the nozzle needle shank, in order to thereby for example open and/or close injection openings, which are formed in different regions of a nozzle body, in time-controlled fashion. Through the use of the additional sleeve-shaped component for limiting the stroke of the nozzle needle tip, the nozzle needle is of relatively cumbersome design.

### SUMMARY OF THE INVENTION

Taking the presented prior art as a starting point, it is the object of the invention to further develop a nozzle needle for a fuel injection device, in particular a fuel injector, such that a structurally simplified embodiment of the nozzle needle which is particularly advantageous from a production aspect is realized.

Said object is achieved according to the invention, in the case of a nozzle needle for a fuel injection device, in that the nozzle needle shank has a receptacle, formed by a blind bore, for the nozzle needle tip, wherein the base of the receptacle forms an axial stop for the nozzle needle tip, and in that the nozzle needle tip has, within the receptacle, a constant diameter which simultaneously forms the largest diameter of the nozzle needle tip. In other words, this means that, by means of the geometrical design of the nozzle needle shank with its blind bore for receiving the nozzle needle tip, a particularly simple geometrical design of the nozzle needle tip can be realized, in the case of which, by contrast to the prior art mentioned in the introduction, the axial stop needs to be formed not by means of a force-fitting connection but rather merely by means of the geometrical design of the receptacle in the nozzle needle shank and the nozzle needle tip. In this way, in particular, the required accuracy or the required tolerance with respect to the diameter in the manufacturing of the individual parts is lessened, because the nozzle needle according to the invention makes it possible to also permit, for example, a sliding fit between the nozzle needle tip and the receptacle in the nozzle needle shank.

Advantageous refinements of the nozzle needle according to the invention for a fuel injection device are specified in the subclaims.

In a particularly preferred embodiment of the nozzle needle tip, the latter is composed of a wear-resistant material such as ceramic, hard metal or a sapphire, and the nozzle needle shank is composed of a solid material composed of steel. Such an embodiment makes it possible to realize a particularly simple, inexpensive and easy-to-machine embodiment of the nozzle needle shank while realizing a particularly wear-resistant design of the nozzle needle tip, such that the nozzle needle, or the fuel injector in which the nozzle needle is installed, has, considered over the entire service life, at least substantially constant closing and opening times as a result of relatively little wear or a relatively small change in geometry of the nozzle needle tip.

It is very particularly preferable if that surface of the nozzle needle tip which acts hydraulically in the direction of the base of the receptacle is larger than that hydraulic surface of the nozzle needle shank which acts in the same direction. Such an embodiment has the effect that, at all times, the nozzle needle tip is acted on in the opening direction of the nozzle needle with a greater hydraulic force than the nozzle needle shank, such that the nozzle needle tip is at all times forced in the direction of the base in the receptacle of the nozzle needle shank. Such an embodiment makes it possible in particular to dispense with an interference fit between the nozzle needle shank and the nozzle needle tip, such that the components can be produced at relatively low cost owing to their lower tolerance requirements.

In particular, it is furthermore provided that the nozzle needle tip has a conically shaped seat region which directly adjoins the region of cylindrical form, arranged within the receptacle, of the nozzle needle tip. In this way, particularly simple manufacture of the nozzle needle tip is possible, because substantially only the nozzle needle tip has to be shaped or formed, if the material of the nozzle needle tip is composed of a bar material, such that the required fit between the nozzle needle tip and the nozzle needle shank is achieved by way of correspondingly exact dimensioning or design of the receptacle in the nozzle needle shank.

In a further embodiment which is preferred from a design aspect, it is provided that the nozzle needle shank has a conical outer surface in the mouth region of the receptacle, and that an elongation of the seat region of the nozzle needle tip running in the direction of the outer surface runs spaced apart from the outer surface. Such an embodiment permits, in particular, an advantageous inflow of fuel in the region of injection openings, and furthermore ensures that only the nozzle needle tip, and not the nozzle needle shank, is arranged in contact with the inner surface of a nozzle body in the closed position.

Furthermore, it may also be provided that an interference fit is formed between the nozzle needle tip and the receptacle. An interference fit is expedient or necessary whenever it can be produced relatively inexpensively with regard to manufacturing costs (depending on the materials used for the nozzle needle shank and the nozzle needle tip and on the dimensioning of the components) and/or if it is sought to prevent any longitudinal displacement of the nozzle needle tip in the receptacle of the nozzle needle shank, for example in order to permit particularly simple installation of the nozzle needle tip in the fuel injector or in order to ensure simultaneous opening of the injection openings with the movement of the nozzle needle shank.

It may however also be provided that a transition or clearance fit is formed between the nozzle needle tip and the receptacle. In this case, particularly simple or inexpensive producibility of the components owing to a relatively large tolerance range of the components is made possible, and furthermore, the installation process is simplified such that the insertion of the nozzle needle tip into the receptacle of the nozzle needle shank is possible particularly easily.

In the latter embodiment with a transition or clearance fit, it may furthermore be provided that at least one leakage gap is formed between the nozzle needle tip and the receptacle. Said leakage gap either may be formed solely owing to the tolerance situation of the components, or else may preferably be realized through targeted machining for example of the nozzle needle tip in the form of a longitudinal groove or the like. Such an embodiment results in a movement slightly delayed in terms of time between the nozzle needle shank and the nozzle needle tip for the opening-up of injection openings.

The invention also encompasses a fuel injection device having a housing for guiding a nozzle needle according to the invention.

### BRIEF DESCRIPTION OF THE DRAWINGS

Further advantages, features and details of the invention will emerge from the following description of preferred exemplary embodiments and from the drawing.

In the drawing:

FIG. 1 shows a partially sectional side view of a nozzle needle according to the invention for a fuel injection device in the form of a fuel injector,

FIG. 2 shows a sub-region of the nozzle needle in the region of the nozzle needle tip, in longitudinal section, and

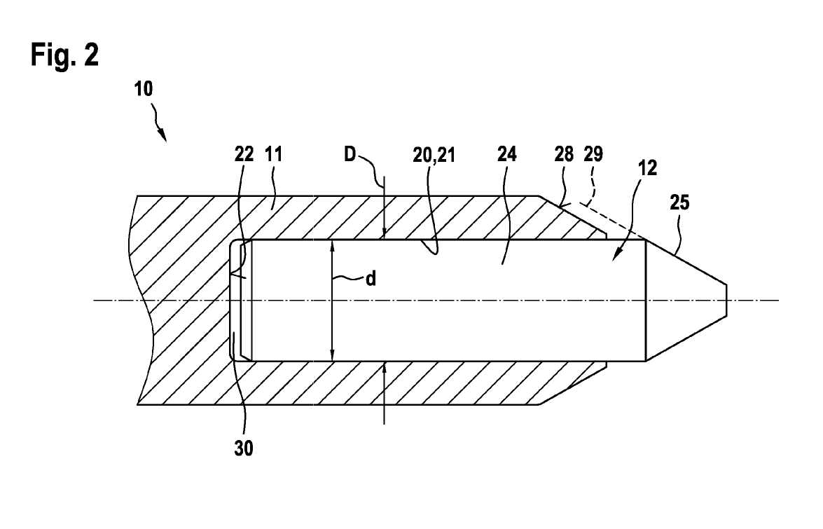

FIG. 3 shows a sub-region of the nozzle needle as per FIGS. 1 and 2 in an installed position in a fuel injector in its closed position, in longitudinal section.

### DETAILED DESCRIPTION

Identical elements or elements of identical function are denoted by the same reference designations in the figures.

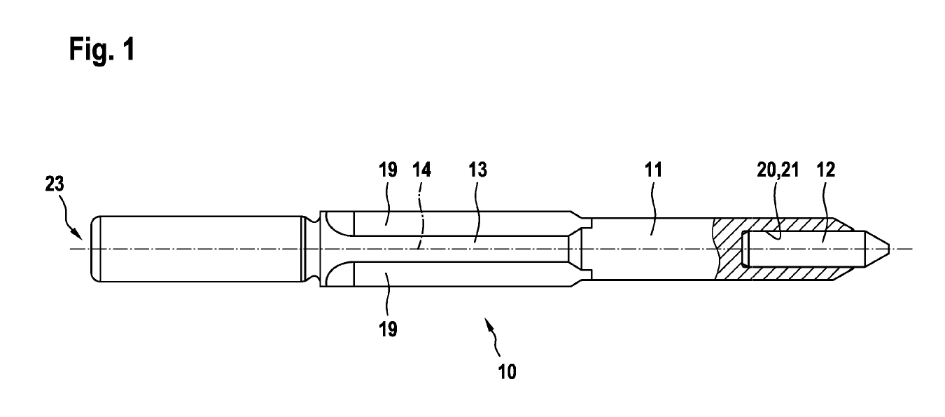

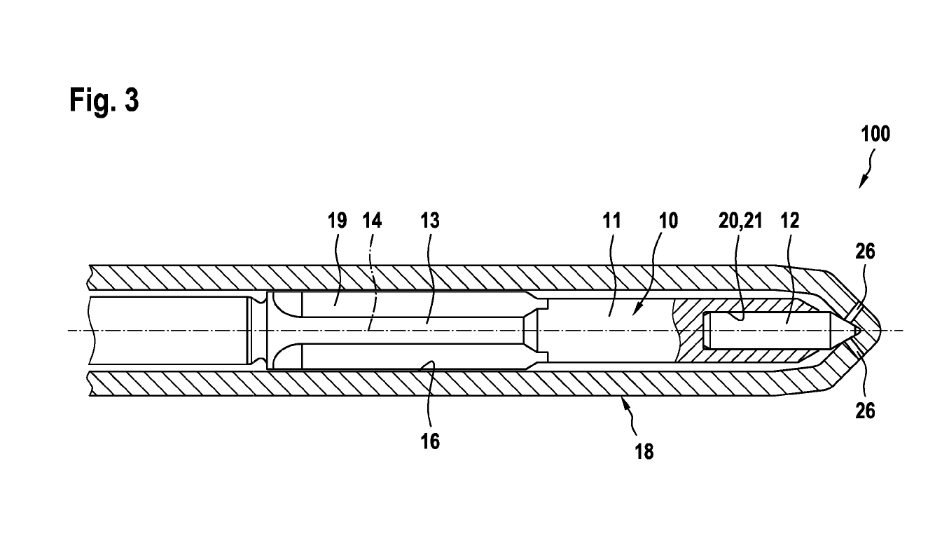

FIG. 1 illustrates a nozzle needle 10 according to the invention for a fuel injection device 100, shown in FIG. 3, in the form of a fuel injector, in particular a fuel injector for use in an auto-ignition internal combustion engine. The fuel injector is a constituent part of a so-called common-rail system, in which highly pressurized fuel is injected into the combustion chamber of an internal combustion engine, such as is prior art per se and will therefore not be discussed in any more detail below.

The nozzle needle 10 is composed substantially of two separate components, a nozzle needle shank 11 and a nozzle needle tip 12. The nozzle needle shank 11 is composed of a solid material, in particular of machine steel, and is of substantially cylindrical or bar-shaped form. The nozzle needle shank 11 has, in a central region, multiple guide sections 13 which serve for radial guidance of the nozzle needle shank 11 or of the nozzle needle 10 in the direction of its longitudinal axis 14 by means of abutment against the inner wall 16 of an injector housing 18 illustrated in FIG. 3. In the region of the guide sections 13, there are formed multiple planar surfaces 19 which are formed in particular by grinding and which are preferably arranged at uniform angular intervals with respect to one another and which serve for allowing fuel to flow in the direction of the nozzle needle tip 12 in the region of the inner wall 16.

The nozzle needle shank 11 has a receptacle 20 in the form of a blind bore 21 for receiving the nozzle needle tip 12. The blind bore 21, which has a constant diameter D, has a base 22 which serves as an axial stop for the nozzle needle tip 12 in the direction of that end 23 of the nozzle needle shank 11 which is situated opposite the nozzle needle tip 12. The end 23 protrudes for example into a control chamber (not illustrated) of the fuel injector in order to control the movement of the nozzle needle 10 for the purposes of opening or closing, in a known manner, injection openings 26 which are formed in the injector housing 18.

The nozzle needle tip 12 is composed of a different material than the nozzle needle shank 11, in particular of a wear-resistant material such as ceramic, hard metal or a sapphire. The nozzle needle tip 12 has, at least within the receptacle 20, a cylindrical section 24 with an at least approximately constant diameter d, wherein the diameter d of the section 24 and the diameter D of the blind bore 21 are coordinated with one another such that, preferably, a transition or clearance fit is formed between the nozzle needle tip 12 and the nozzle needle shank 11, and wherein the diameter d simultaneously forms the largest diameter of the nozzle needle tip 12. It is however also possible for the diameters d, D to be coordinated with one another such that an interference fit is formed between the nozzle needle tip 12 and the nozzle needle shank 11. It is furthermore possible for leakage grooves or the like (not illustrated) to be formed on the circumference of the section 24 in order to permit a defined throughflow of fuel into the region of the base 22 of the blind bore 21.

The section 24 of cylindrical form of the nozzle needle tip 12 is adjoined, outside the receptacle 20, by a seat region 25 of conical form. The seat region 25 is designed to close the injection openings 26 when the nozzle needle 10 is in the closed position illustrated in FIG. 3. For this purpose, the seat region 25 bears sealingly against the inner wall 16 of the injector housing 18.

The nozzle needle shank 11 has a outer surface 28 of conical form in the mouth region of the receptacle 20 or of the blind bore 21. A straight line 29 formed as an elongation of the seat region 25 runs spaced apart from the outer circumference 28 of the nozzle needle shank 11.

If a transition or clearance fit is formed between the nozzle needle tip 12 and the nozzle needle shank 11 in the region of the receptacle 20, fuel can pass into the region between the base 22 of the blind bore 21 and that face surface of the nozzle needle tip 12 which faces toward the base 22. During the opening of the nozzle needle 10 from the closed position illustrated in FIG. 3 for the purposes of opening up the injection openings 26, from the first moment, the nozzle needle shank 11 begins to move such that an axial gap 30 forms between the base 22 of the blind bore 21 and the nozzle needle tip 12, which axial gap has a size in the region of a few micrometers. Subsequently, the nozzle needle tip 12 also begins to move away from its sealing seat in order to open up the injection openings 26.

It is also essential that the force acting hydraulically on the nozzle needle tip 12 in the opening direction of the nozzle needle 10 owing to the fuel pressure in the injector housing 18 is always greater than the force acting hydraulically on the nozzle needle shank 11, such that the nozzle needle tip 12 is subjected to force in the direction of the base 22 of the blind bore 21 at all times.

The nozzle needle 10 thus described, and the fuel injection system 100, may be altered or modified in a variety of ways without departing from the concept of the invention.

1. A nozzle needle (10) for a fuel injection device (100), the nozzle needle comprising a nozzle needle tip (12) which is connected to a nozzle needle shank (11), wherein the nozzle needle tip (12) and the nozzle needle shank (11) are composed of different materials,
wherein the nozzle needle shank (11) has a receptacle (20), formed by a blind bore (21), for the nozzle needle tip (12), wherein a base (22) of the receptacle (20) forms an axial stop for the nozzle needle tip (12), and wherein the nozzle needle tip (12) has, within the receptacle (20), an at least approximately constant diameter (d) which simultaneously forms the largest diameter of the nozzle needle tip (12).

2. The nozzle needle as claimed in claim 1,
wherein the nozzle needle tip (12) is composed of a wear-resistant material, and the nozzle needle shank (11) is composed of a solid material composed of steel.

3. The nozzle needle as claimed in claim 1,
wherein a surface of the nozzle needle tip (12) which acts hydraulically in the direction of the base (22) of the receptacle (20) is larger than a hydraulic surface of the nozzle needle shank (11) which acts in the same direction, such that the nozzle needle tip (12) is subjected to force in the direction of the base (22) of the receptacle (20) at all times.

4. The nozzle needle as claimed in claim 1,
wherein the nozzle needle tip (12) has a conically shaped seat region (25) which adjoins a section (24) of cylindrical form within the receptacle (20).

5. The nozzle needle as claimed in claim 4,
wherein the nozzle needle shank (11) has a conical outer surface (28) in a mouth region of the receptacle (20), and wherein an elongation (29) of the seat region (25) running in the direction of the outer surface (28) runs spaced apart from the outer surface (28).

6. The nozzle needle as claimed in claim 1,
wherein an interference fit is formed between the nozzle needle tip (12) and the receptacle (20).

7. The nozzle needle as claimed in claim 1,
wherein a transition or clearance fit is formed between the nozzle needle tip (12) and the receptacle (20).

8. The nozzle needle as claimed in claim 7,
wherein at least one leakage gap is formed between the nozzle needle tip (12) and the receptacle (20).

9. A fuel injection device (100), comprising a housing (18) for guiding a nozzle needle (10), wherein the nozzle needle (10) includes a nozzle needle tip (12) which is connected to a nozzle needle shank (11), wherein the nozzle needle tip (12) and the nozzle needle shank (11) are composed of different materials, wherein the nozzle needle shank (11) has a receptacle (20), formed by a blind bore (21), for the nozzle needle tip (12), wherein a base (22) of the receptacle (20) forms an axial stop for the nozzle needle tip (12), and wherein the nozzle needle tip (12) has, within the receptacle (20), an at least approximately constant diameter (d) which simultaneously forms the largest diameter of the nozzle needle tip (12).

10. The fuel injection device as claimed in claim 9,
wherein the nozzle needle tip (12) is composed of a wear-resistant material, and the nozzle needle shank (11) is composed of a solid material composed of steel.

11. The fuel injection device as claimed in claim 9,
wherein a surface of the nozzle needle tip (12) which acts hydraulically in the direction of the base (22) of the receptacle (20) is larger than a hydraulic surface of the nozzle needle shank (11) which acts in the same direction, such that the nozzle needle tip (12) is subjected to force in the direction of the base (22) of the receptacle (20) at all times.

12. The fuel injection device as claimed in claim 9,
wherein the nozzle needle tip (12) has a conically shaped seat region (25) which adjoins a section (24) of cylindrical form within the receptacle (20).

13. The fuel injection device as claimed in claim 12,
wherein the nozzle needle shank (11) has a conical outer surface (28) in a mouth region of the receptacle (20), and wherein an elongation (29) of the seat region (25) running in the direction of the outer surface (28) runs spaced apart from the outer surface (28).

14. The fuel injection device as claimed in claim 9,
wherein an interference fit is formed between the nozzle needle tip (12) and the receptacle (20).

15. The fuel injection device as claimed in claim 9,
wherein a transition or clearance fit is formed between the nozzle needle tip (12) and the receptacle (20).

16. The fuel injection device as claimed in claim 15,
wherein at least one leakage gap is formed between the nozzle needle tip (12) and the receptacle (20).

17. The fuel injection device as claimed in claim 9,
wherein the nozzle needle tip (12) is composed of ceramic, hard metal or a sapphire, and the nozzle needle shank (11) is composed of a solid material composed of steel.

18. The nozzle needle as claimed in claim 1,
wherein the nozzle needle tip (12) is composed of ceramic, hard metal or a sapphire, and the nozzle needle shank (11) is composed of a solid material composed of steel.
